(19) United States
(12) Patent Application Publication
(10) Pub. No.: US 2007/0276676 A1
(43) Pub. Date: Nov. 29, 2007

(54) SOCIAL INFORMATION SYSTEM

(76) Inventors: Christopher Hoenig, Washington, DC (US); Timothy T.K. Choo, Framingham, MA (US)

Correspondence Address: HOFFMAN, WARNICK & D'ALESSANDRO LLC, 75 STATE ST, 14 FL, ALBANY, NY, 12207, US

(21) Appl. No.: 11/419,808

(22) Filed: May 23, 2006

(51) Int. Cl. G06Q 10/00; G06Q 30/00

(52) U.S. Cl. 705/1

(57) ABSTRACT

A system and method for providing a social information system for managing socio-technical information. A system is provided that includes: a regulation engine for capturing data from a set of heterogeneous data sources and transforming the data into a common representation; a data standardization system for storing the data in a data warehouse in accordance with a defined data model; and an interaction engine having a workspace for allowing users to interact with data from the data warehouse, wherein the interaction engine includes a customization system for defining a lens for the user according to a taxonomy associated with the user, wherein the lens filters the data being viewed in the workspace to a presentation and granularity that conforms to the taxonomy.

### FIELD OF THE INVENTION

The invention relates generally to collaborative data analysis and processing, and more particularly, to a social information system that collects heterogeneous socio-technical data and provides an interface through which different types of users can define and exploit the data for decision-making in a rich environment.

### BACKGROUND OF THE INVENTION

A continuing problem faced by jurisdictions (e.g., nations, provinces, regions, communities, etc.), affinity groups (e.g., health, education, poverty, economics, etc.), and institutions (e.g., government agencies, non-government organizations (NGOs), etc.) is how to continually assess and improve the progress of their societies and how to evaluate their role in contributing to that progress. This demand arises from fractured communities without shared frames of reference that face complex choices with too little usable information. They need information on measurable progress toward goals and richer information on changing societal conditions in more valuable forms that can help citizens, special interest groups, civil society, the media, and policymakers. Current solutions in this field, such as in the areas of collaboration, content management or business intelligence systems, take a fractured approach to the problem, showing static views of compartmentalized information in web portals with only basic search and download capabilities. Current solutions, though theoretically targeted at large-scale audiences, also do not in fact have the capability to reach the many diverse individuals and institutions that would use the information on a regular basis for decision-making and collaborative action.

Users have increasingly complex needs not met by these existing solutions. They want to see relevant information pulled together on a large scale from a variety of sources and presented holistically. To meet this need, institutions and jurisdictions need more integrated data about societal progress, presented in a more interactive and dynamic interface, supporting collaborative innovation and decision-making, with a comprehensive services method for implementation.

Current social information systems (also referred to herein as “socio-technical systems”) generally fall into two classes: The first class is static, inflexible and difficult to use, but it does allow users to interact around a wide variety of known and unknown issues in a societal landscape using data from heterogeneous sources across a broad temporal spectrum. The second class—found primarily in the defense or commercial markets—is dynamic, flexible and sophisticated in allowing fused interaction with military or commercial landscapes. However, this second class deals with a focused set of known issues from sources that is homogenous across a narrow temporal spectrum and from a narrowly bounded set of perspectives. Present day systems fail to combine the key attributes of both these classes to provide the capacity for dynamic interaction while sourcing and publishing information across a wide-variety of heterogeneous issues viewed from a nearly unbounded set of perspectives, in a collaborative environment.

Accordingly, a need exists for such a social information system that will provide an architecture and toolset that will support advanced capabilities, including the ability to customize, map, drill down, analyze, and visualize information from disparate data sources, and be scalable to the immense number of users and groups who could benefit from access to changing information on the progress of their societies.

### SUMMARY OF THE INVENTION

The present invention addresses the above-mentioned problems, as well as others, by providing a social information system that provides dynamic interaction to information across a wide variety of heterogeneous issues viewed from a nearly unbounded set of perspectives. The invention includes a large-scale information system that provides key indicators of changing societal conditions to numerous audiences (e.g., citizens, special interest groups, policymakers, and the media) in definable jurisdictions (cities, regions, provinces, nations, etc.). It enables groups (e.g., governments, NGOs, the media, information providers, businesses, affinity groups, etc.) to manage their progress in a collaborative fashion, and connects diverse audiences with evolving information and the tools with which to analyze and act upon it.

In a first aspect, the invention provides a social information system for managing socio-technical data, comprising: a regulation engine for capturing data from a set of heterogeneous data sources and transforming the data into a common representation; a data standardization system for storing the data in a data warehouse in accordance with a defined data model; and an interaction engine having a workspace for allowing a user to interact with data from the data warehouse, wherein the interaction engine includes a customization system for defining a lens for the user according to a taxonomy associated with the user, wherein the lens filters the data being viewed in the workspace to a presentation and granularity that conforms to the taxonomy.

In a second aspect, the invention provides program product stored on a computer usable medium for managing socio-technical data, comprising: program code configured for capturing data from a set of heterogeneous data sources and transforming the data into a common representation; program code configured for storing the data in a data warehouse in accordance with a defined data model; and program code configured for providing a workspace for allowing a user to interact with data from the data warehouse, wherein the workspace includes program code configured for defining a lens for the user according to a taxonomy associated with the user, wherein the lens filters the data being viewed in the workspace to a presentation and granularity that conforms to the taxonomy.

In a third aspect, the invention provides a social information system for managing socio-technical data, comprising: a regulation engine for capturing data from a set of heterogeneous data sources and transforming the data into a common representation; a data standardization system for storing the data in a data warehouse in accordance with a defined data model; and a workspace for allowing a user to interact with data from the data warehouse, wherein the workspace allows users to manage data constructs involving socio-technical data and includes a simulation engine for simulating outcomes of socio-technical issues by adjusting at least one variable associated with a data construct.

In a fourth aspect, the invention provides a method for deploying a social information system for managing socio-technical data, comprising: providing a computer infrastructure being operable to: capture data from a set of heterogeneous data sources and transforming the data into a common representation; store the data in a data warehouse in accordance with a defined data model; and provide a workspace for allowing a user to interact with data from the data warehouse, wherein the workspace allows users to manage data constructs involving socio-technical data and includes a simulation engine for simulating outcomes of socio-technical issues by adjusting at least one variable associated with a data construct.

In a fifth aspect, the invention provides computer software embodied in a propagated signal for implementing a social information system for managing socio-technical data, the computer software comprising instructions to cause a computer to perform the following functions: capture data from a set of heterogeneous data sources and transforming the data into a common representation; store the data in a data warehouse in accordance with a defined data model; and at least one of: provide a workspace for allowing a user to interact with data from the data warehouse, wherein the workspace allows users to manage data constructs involving socio-technical data and includes a simulation engine for simulating outcomes of socio-technical issues by adjusting at least one variable associated with a data construct; and provide a workspace for allowing a user to interact with data from the data warehouse, wherein the interaction engine includes a customization system for defining a lens for the user according to a taxonomy associated with the user, wherein the lens filters the data being viewed in the workspace to a presentation and granularity that conforms to the taxonomy.

The invention assimilates data from a plurality of data sources into a common, centralized data repository, where the data is standardized and cleansed before being disseminated to users through both web-based and rich client presentation interfaces. The data standardization process ensures that data from disparate sources is rationalized into a common data model, is optimized for analytical operations, and can be presented holistically rather than in a fragmented manner. The data may be comprised of metrics and indicators that reflect the progress of a group (e.g., nation, state, city, or other jurisdiction) and cover a range of topical areas such as health, the environment, the economy, security, quality of life, diversity, etc., enabling people and groups to measure progress in these areas and others.

The cumulative functions of the invention can provide a central “e-society” platform for entire jurisdictions or affinity groups. The system is extremely usable for information browsers seeking to learn and explore—users may browse standard reports and perform manipulative functions on the data through custom queries. The system can also be a tool for advanced, large-scale users who wish to extract data and/or repackage it for further distribution or use. The system also demonstrates a high degree of utility for decision and policy makers. Users can perform simulations to see how different factors might change or affect each other over time, facilitating more informed resource allocation. Users may also view the data from a geographic perspective, e.g., with a geospatial interface, enabling comparisons among jurisdictions. Finally, the system provides users with a platform and tools for collaborative problem-solving, making the information not only accessible, but actionable.

Instead of serving a narrow audience spectrum with a system whose information quality and architecture is determined by the provider's point-of-view, the invention serves a broad spectrum of users with a flexible information architecture that is a function of the user's point-of-view. The following features breach key scaling factors that have inhibited the creation of systems that engage large-scale societal audiences.

First, instead of viewing user segments in a narrow range, user groups are conceptualized on a broad, multi-dimensional spectrum, from passive users to self-editors, self-publishers, self-analysts, and self-researchers. Users have interests ranging from specific issues to the state of entire jurisdictions, and play roles from policymaking and reporting to resource allocation.

Second, the system is based on the complete transparency of information quality irrespective of the source, which allows the users, not the provider, to assess relative information quality. Existing information systems depend on the opaqueness of information production processes, while this system is based on the idea that scarcity and transparency of quality information is more likely to generate meaningful market activity.

Third, this system is based on the idea that user cognitive frames of reference should be technically exposed and used to enhance the degree of user engagement with the system. Current systems simply take alternative cognitive frames for granted or incorporate them into the information architecture rather than the present invention that creates a meta-architecture that allows multiple frames.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a social information system in accordance with an embodiment of the present invention.

FIG. 2 depicts a customization system in accordance with an embodiment of the present invention.

FIG. 3 depicts a data valuation system in accordance with an embodiment of the present invention.

FIG. 4 depicts a data analysis and decision-making system in accordance with an embodiment of the present invention.

FIG. 5 depicts a collaboration system in accordance with an embodiment of the present invention.

### DETAILED DESCRIPTION OF THE INVENTION

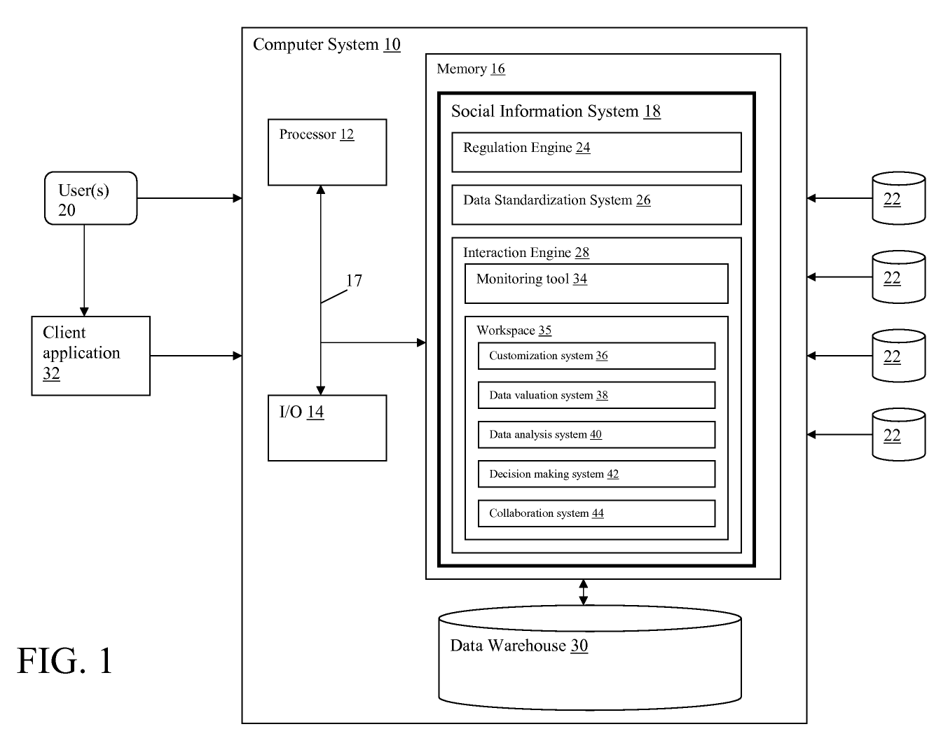

Referring now to drawings, FIG. 1 depicts a computer system 10 having a social information system 18 for providing socio-technical information to users 20 either typical scenario, social information system 18 would be made available by a service provider over a network, such as the Internet. Included with the social information system 18 is a data warehouse 30 that acts as a central repository of all data collected from various information sources 22 (e.g., governmental, commercial or other private enterprises). Data warehouse 30 may also collect data from the wide variety of different interactions taking place within the social information system 18 by users 20. As described in further detail below, the data warehouse 30 provides unique views for both the system provider and users 30 to create a self-learning, self-evolving community.

A regulation engine 24 is provided to manage the data feeds and structures (“source data”) from the various information sources 22 as the source data enters the social information system 18. Regulation engine 24 may also capture source data from users 20 of the social information system 18. The source data may arrive in a variety of formats, depending on the information source 22. Regulation engine 24 is configured to understand a multitude of data syntactical formats (e.g., HTML, XML, DB2, MPEG, JPEG, SQL, etc.) and transform the source data to a common representation (e.g., XML, DB2, SQL, etc.). Regulation engine 24 also manages the scheduling and frequency of data updates (e.g., in the case where source data is pulled into the system). In other cases where data is pushed into the system (e.g., by an RSS feed), regulation engine 24 may includes buffers and filters to capture relevant data.

Once the source data is transformed to the common representation, it is fed to the data standardization system 26 that stores the data in accordance with a defined data model. The data model may be implemented in any manner (e.g., using unified modeling language “UML,” fuzzy logic, etc.). The data standardization system 26 provides various functions, including:

a. Standardizing codes in the data to descriptive text

b. Normalizing names and addresses

c. Removing redundancies

d. Converting to a standard unit of measure

e. Rationalizing data in the appropriate level of granularity

f. Mapping the data into a model that is suitable for reporting and manipulation

g. Adding metadata tags to specify properties of the raw data

Once processed, the source data is stored into the data warehouse 30, where it can be exploited by the users via interaction engine 28. Interaction engine 28 includes a workspace 35 in which a user 20 can manipulate and analyze data from the data warehouse 30. In an illustrative embodiment, interaction engine 28 is implemented as a portal that provides advanced functionality for users 20 who log in. Aside from standard reports found in typical existing systems, interaction engine 28 provides users 20 with a layered set of interactions to use, manipulate, extract, or produce information in a variety of ways, depending on individual perspectives, needs, and purposes. Examples of the different layers of user experience are described below. In addition, a monitoring tool 34 is provided to collect detailed information on patterns of user interaction with the social information system 18 to enable inferences from collective behavior for either the system manager or the users 20 themselves.

In general, computer system 10 may comprise any type of computing device, and may be implemented as server in a client-server environment. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, data feed, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

Data warehouse 30 may also be implemented using any type of known storage devices and systems (e.g., a relational database management system, an object oriented database management system, etc.). Moreover, data warehouse 30 may reside at a single physical location or be implemented in a distributed fashion, e.g., over a network.

As noted above, interaction engine 28 includes a layered set of interactions that allow users 20 to manipulate data in the data warehouse 30. All of interactions are accessed through workspace 35 in which data constructs can be selected, defined, manipulated, simulated, etc. A data construct may be defined as any aspect of a society reflected in a set of data. In many instances, the data construct includes indicators, which can provide variables through which the user can perform advances analysis (e.g., overlaying different sets of information, simulating an outcome, etc.). For instance, a user may select from the data warehouse 30 a data construct that includes year-to-year water consumption for a county. The user 20 may want to know how population affects consumption, and therefore could add (i.e., overlay) a population indicator into the data construct. The user 20 might then select population as a variable, and simulate outcomes of water consumption based on population growth.

The layered set of interactions include: (1) a customization system 36 that allows each user 20 to define the cognitive frame of reference through which the user will view, analyze and interpret information; (2) a data valuation system 38 that allows users 20 to regulate which areas of information they wish to engage in and to also rate the information they receive from the data warehouse 30; (3) a data analysis system 40 that provides various analysis tools required for the user 20 to gain maximum understanding of an issue or question from the data; (4) a decision-making system 42 that provides the key decision-making tools that enable users 20 to make informed choices from the data; and (5) a collaboration system 44 that provides the collaborative and communication tools for users 20 to expand their individual work into collective work with others.

As noted above, users 20 with more advanced interaction requirements can use a rich client application 32 instead of a web browser interface. This client application 32 offers the all the advantages of a locally installed application yet is provisioned and managed through the network, allowing for ease of deployment and maintenance. Whenever the user accesses a specific functional set of tools, they are, e.g., dynamically downloaded to the client application 32 and loaded as a plug-in module.

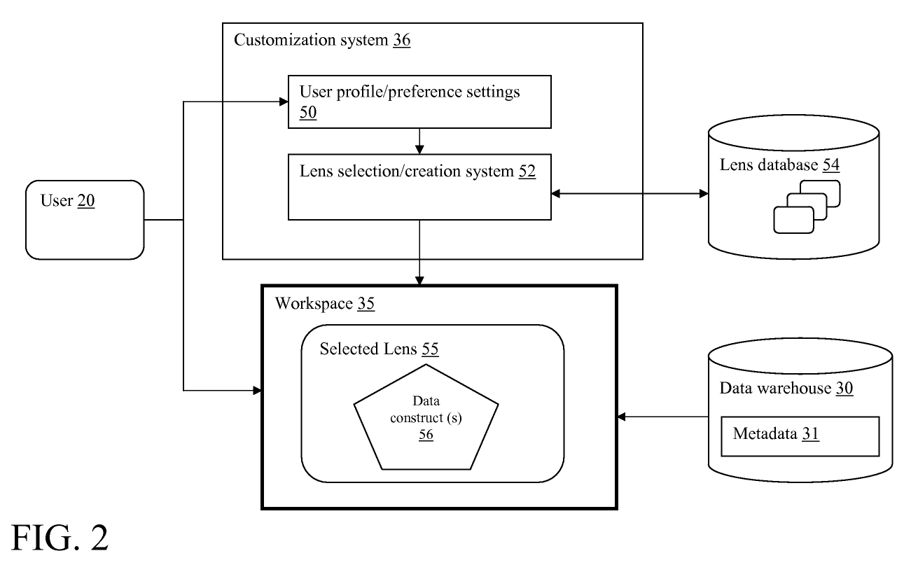

FIGS. 2-5 depict illustrative embodiments of the above described systems that provide the layered set of interactions. FIG. 2 depicts a customization system 36 that includes user profile/preference settings 50 and a lens selection/creation system 52. Each lens provides a polymorphic taxonomization though which data can be presented. Lenses can either be selected, e.g., from a lens database 54, or be created, e.g., with a tool based on user inputs. The selected or creation of the lens may also be determined based on the user profile/preference settings 50.

Each lens uniquely filters data to a presentation format and granularity that is appropriate for the particular user 20. Data may be filtered based on any number of different taxonomies (e.g., interest group of the user, jurisdiction of interest, education of the user, etc.) to provide a polymorphic taxonomization.

For instance, if the user 20 was a high school student doing county-wide census research for a social studies class, then a lens suitable for viewing and processing data at a relatively basic level of granularity would be selected. Conversely, if the user 20 was a politician doing research on the impact of a redistricting proposal within the same county, then a lens would be selected to provide political information (such as voting and political affiliation information), tax information, geographic data, etc. Further, if the user 20 was a city planner examining the transportation infrastructure of the county, then a lens could be selected that would favor detailed road and rail data, transportation funding data, traffic patterns, accident data, etc.

Once chosen, the selected lens 55 can be overlaid into workspace 35, which would cause data constructs 56 being viewed and analyzed to be presented at a level of scope and detail commensurate with the selected lens 55. Thus, data constructs 56 regarding county-wide data presented to the high school student would be significantly different than the data constructs 56 presented to the politician, which would be significantly different for data constructs 56 presented to the city planner.

As noted above, data warehouse 30 is provided with extensive metadata 31. Metadata 31 is one mechanism that allows different lenses to select and filter data differently. For instance, property tax records may be tagged with metadata indicating that they have budgetary, political, educational and business significance. Accordingly, whenever property information is examined through a lens that includes a taxonomy that matches one or more of these criteria, property tax records would likely be made available.

In summary, customization system 36 determines the cognitive frame of reference through which the user 20 will view, analyze, and interpret information. It should be understood that mechanisms for implementing the user profile/preference settings 50, as well as the lens selection/creation system 52, could be done in any manner. For instance, a custom “lens” interface could be designed using Bayesian rules based on choices of successive information and interaction parameters. Moreover, the number, type, and dimensionality of lenses are virtually unlimited. For instance, user 20 could define a lens based on role-based taxonomies (private citizen, reporter, policymaker, medical professionals, business owner, etc), point-of-view-based taxonomies (e.g., democrat, environmentalist, etc.), interest-based taxonomies, etc. Once created, lenses can be discarded, saved, or evolved over time.

Moreover, based on the profile/preference settings 50, the user 20 can be automatically notified via email when information on a particular issue is updated.

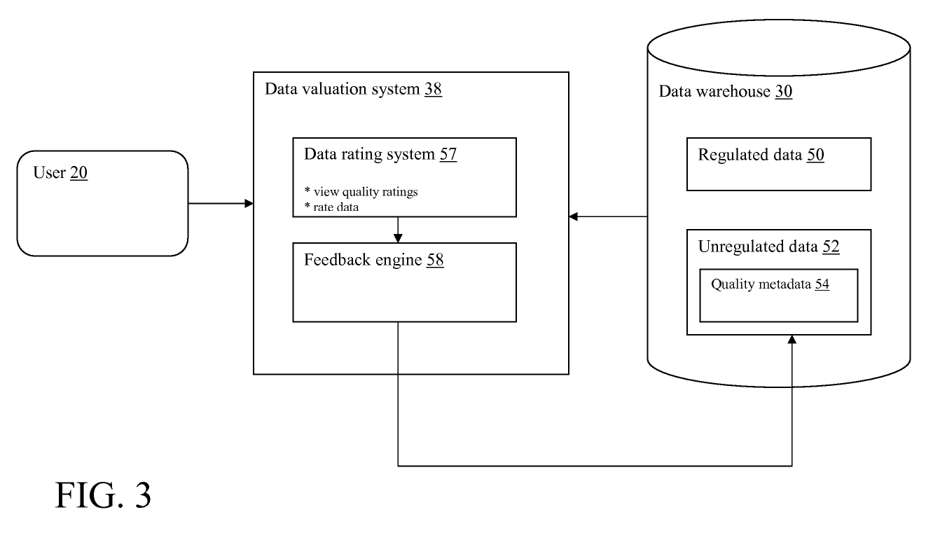

Referring now to FIG. 3, a data valuation system 38 is shown that includes a data rating system 57 and a feedback engine 58. In order to provide quality or value information about data in data warehouse 30, data is divided into one of at least two categories, regulated data 50 and unregulated data 52. Regulated data 50 generally represents data that is known to be reliable, e.g., maps, government tax data, census data, DMV records, etc. Alternatively, unregulated data 52 represents data for which the reliability or quality is unknown, e.g., data from a blog, reports created by other users, etc. This then allows the integration engine 28 to host and distribute uniquely combined data perspectives—both regulated and unregulated—that might not be available anywhere else.

Data rating system 57 allows users 20 to both view quality ratings for data and rate the data itself. Quality ratings allow the user 20 to focus in on data that is likely to be more useful and reliable. For example, data rating system 57 can perform tasks such as sort data so that the highest-rated data appears first. Furthermore, for each indicator presented in a data construct, a multidimensional graphic showing the key elements of information quality may appear with direct links to metadata elements and descriptions. Users 20 can then get an overall gestalt of relative information quality dimensions and click through to specifics in order to decide if the information is fit for a particular use.

As noted, data rating system 56 also allows the user 20 to rate unregulated data 52 as the user 20 is viewing and processing data constructs in the workspace 35. Feedback engine 58 provides a mechanism through which quality metadata can be assigned to unregulated data 52 and stored in data warehouse 30.

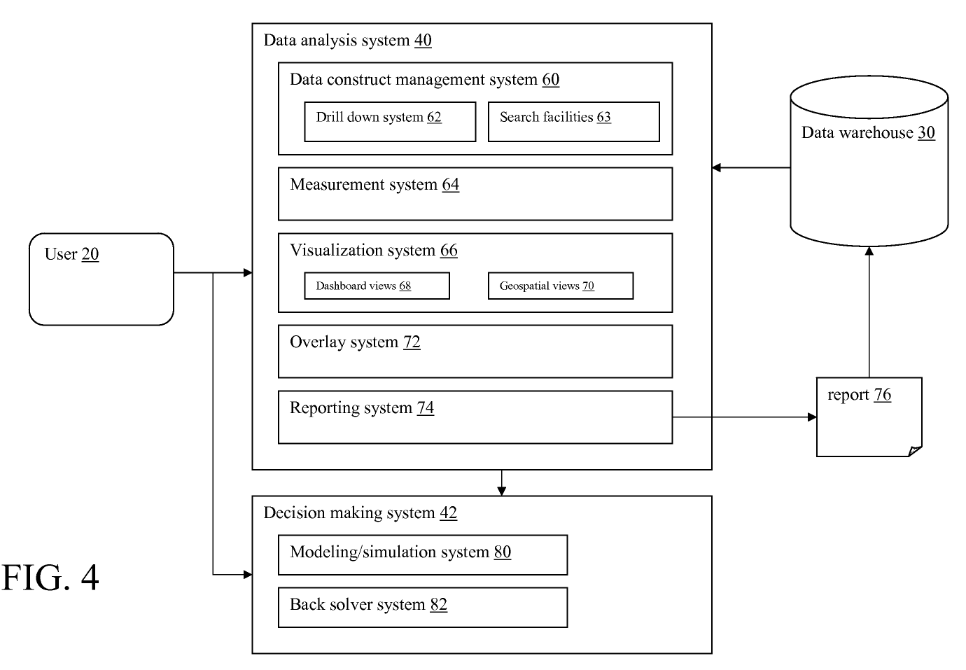

Referring now to FIG. 4, data analysis system 40 and decision-making system 78 are described in further detail. Data analysis system 40, which is the primary tool for interfacing with data from data warehouse 30, includes: a data construct management system 60, a measurement system 64, a visualization system 66, an overlay system 72, and a reporting system 74. Data construct management system 60 provides the mechanism for importing, identifying, inputting, defining, selecting, creating, etc., data constructs from the data warehouse 30. Supporting tools may include, e.g., a drill down system 62 for viewing data at different levels of granularity, a search facility 63 for locating data in the data warehouse 30, etc.

Thus, for instance, if user 20 is interested in the status of a certain construct (e.g., the caliber of high school education in his town), user 20 could initiate a search to locate data indicators that would form the construct. On selected, user 20 could drill down (or up) as necessary to find the data indicators of interest. Measurement system 64 allows the user to analyze each of the data indicators, and also presents choices of alternative indicator clusters that might be of interest. Metadata tags may be provided to display the source of the underlying data.

Visualization system 66 provides a menu of visualization choices, e.g., dashboard views 68, geospatial views 70, etc., that allows the user 20 to view the data in different formats. For example, using a geospatial view 70, the user 20 may be able to see a distribution of the information throughout his state using satellite imagery. From this view, the user 20 could then drill down on the map, zooming in and out as necessary to see data for different jurisdictional levels.

Overlay system 72 allows the user to overlay data points on top of each other. For instance, using a mapping interface, user 20 can drag and drop additional data points (e.g., household income, highest educational level attained) onto a map to see it overlaid with high school education data. Statistical correlations among the metrics can then be calculated and displayed by overlay system 72.

Reporting system 74 provides a mechanism for generating and saving reports and other output of interest. If desired, a generated report 76 can be loaded into the data warehouse 30 (as unregulated data 52), where other users can view and further manipulate it.

Decision making system 42 provides the user 20 with a number of options for decision-making assistance, ranging from simple choice trees and simulation tools to decision-making widgets and intelligent assistants for particular issues. Information from the system can be uploaded into various types of existing decision tools.

One such feature provided by decision making system 42 is modeling/simulation system 80 that allows the user 20 to perform what-if scenarios based on selected data indicators (i.e., variables). For example, user 20 could open a modeling/simulation window that allows the manipulation of various variables that he or she believes feed into educational results (e.g., funding for public education). By manipulating the variables and allowing the simulation to run over a period of time (e.g., 10 years), user 20 can see a modeled outcome, for example, how are high school increased in the town as funding increases. In addition, a back-solver system 82 is provided that allows the user 20 to enter a desired result and see how much of each variable it would take to achieve the result. For example, to achieve a certain average SAT results for a jurisdiction, how much additional funding is required?

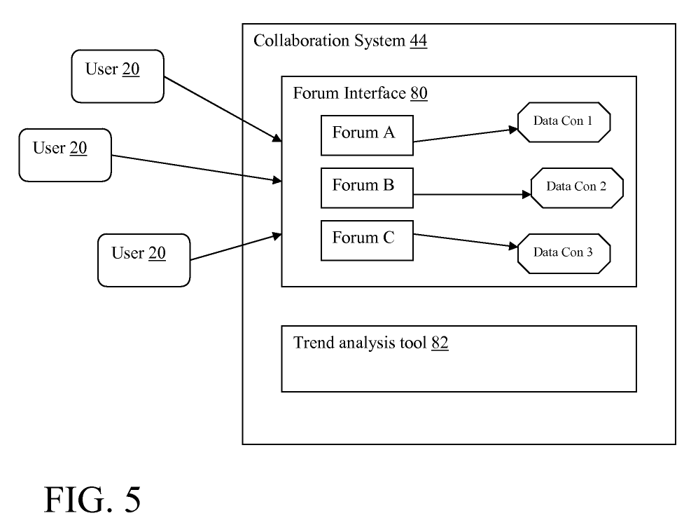

Referring now to FIG. 5, collaboration system 44 is shown having a forum interface 80 and a trend analysis tool 82. Forum interface 80 provides an interface in which users 20 can engage in a collaborative discussion forum that is linked to a particular data construct (e.g., a first user may start a discussion thread on the status of public education in a town). Other users may respond by pointing the first user to different data overlays they have discovered when exploring the information (which e.g., show that in addition to funding, other factors such as student-teacher ratios also directly impact educational results).

Trend analysis tool 82 allows the user 20 to gather trend information, e.g., on what residents of his town think about raising taxes to fund schools and raise student-teacher ratios. Trend analysis tool 82 can also be configured to crawl blogs, news articles, online discussion forums, and other Web sites to generate a probability that such a bill would pass. With that information, a decision maker can decide what actions to take, e.g., draft a bill.

Collaboration system 44 may be implemented as a web-based user interface to provide the primary channel for information dissemination. The interface could use industry-standard protocols in an innovative fashion (for example, asynchronous AJAX calls to repaint the screen resulting in an improved user experience). Custom rich client interfaces 32 could also support the advanced analysis functionality described above.

It should be appreciated that the teachings of the present invention could be offered as a business method on a subscription or fee basis. For example, a computer system 10 comprising social information system 18 could be created, maintained and/or deployed by a service provider that offers the functions described herein for customers. That is, a service provider could offer to provide the various data analysis systems described above.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part or all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A social information system for managing socio-technical data, comprising:
a regulation engine for capturing data from a set of heterogeneous data sources and transforming the data into a common representation;
a data standardization system for storing the data in a data warehouse in accordance with a defined data model; and
an interaction engine having a workspace for allowing a user to interact with data from the data warehouse, wherein the interaction engine includes a customization system for defining a lens for the user according to a taxonomy associated with the user, wherein the lens filters the data being viewed in the workspace to a presentation and granularity that conforms to the taxonomy.

2. The social information system of claim 1, wherein the taxonomy is determined based on a profile associated with the user.

3. The social information system of claim 1, wherein the taxonomy is selected from the group consisting of: an interest, a jurisdiction, an education level, an affinity group and a political affiliation.

4. The social information system of claim 1, wherein the interaction engine further includes a data valuation system that provides a quality value to unregulated data in the data warehouse, and allows the user to assign and feedback a quality value to data stored in the data warehouse.

5. The social information system of claim 1, wherein the interaction engine further includes a data analysis system for: managing data constructs obtained from the data warehouse, generating different views of data constructs, and overlaying further information onto a selected data construct.

6. The social information system of claim 1, wherein the interaction engine further includes a decision-making system that allows the user to simulate outcomes in a society based on at least one variable used to define a construct.

7. The social information system of claim 1, wherein the interaction engine further includes a collaboration system that allows users to engage in online forums about different data constructs.

8. A program product stored on a computer usable medium for managing socio-technical data, comprising:
program code configured for capturing data from a set of heterogeneous data sources and transforming the data into a common representation;
program code configured for storing the data in a data warehouse in accordance with a defined data model; and
program code configured for providing a workspace for allowing a user to interact with data from the data warehouse, wherein the workspace includes program code configured for defining a lens for the user according to a taxonomy associated with the user, wherein the lens filters the data being viewed in the workspace to a presentation and granularity that conforms to the taxonomy.

9. The program product of claim 8, wherein the taxonomy is determined based on a profile associated with the user.

10. The program product of claim 8, wherein the taxonomy is selected from the group consisting of: an interest, a jurisdiction, an education level, an affinity group and a political affiliation.

11. The program product of claim 8, wherein the workspace further includes program code configured for obtaining quality values associated with unregulated data in the data warehouse, and for allowing the user to feedback quality values to data stored in the data warehouse.

12. The program product of claim 8, wherein the workspace further includes program code configured for: managing data constructs obtained from the data warehouse, generating different views of data constructs, and overlaying further information onto a selected data construct.

13. The program product of claim 8, wherein the workspace further includes program code configured for simulating outcomes in a society based on at least one variable used to define a construct.

14. The program product of claim 8, wherein the workspace further includes program code configured for allowing users to engage in online forums about different data constructs.

15. A social information system for managing socio-technical data, comprising:
a regulation engine for capturing data from a set of heterogeneous data sources and transforming the data into a common representation;
a data standardization system for storing the data in a data warehouse in accordance with a defined data model; and
a workspace for allowing a user to interact with data from the data warehouse, wherein the workspace allows users to manage data constructs involving socio-technical data and includes a simulation engine for simulating outcomes of socio-technical issues by adjusting at least one variable associated with a data construct.

16. The social information system of claim 15, further comprising a customization system for defining a lens for the user according to a taxonomy associated with the user, wherein the lens filters the data being viewed in the workspace to a presentation and granularity that conforms to the taxonomy of the user.

17. The social information system of claim 16, wherein the taxonomy is selected from the group consisting of: an interest, a jurisdiction, an education level, an affinity group and a political affiliation.

18. The social information system of claim 15, wherein the workspace further includes a data valuation system that allows the user to obtain quality values for unregulated data in the data warehouse, and allows the user to assign and feedback quality values to data stored in the data warehouse.

19. The social information system of claim 15, wherein the workspace further includes a data analysis system for: managing data constructs obtained from the data warehouse, generating different views of data constructs, and overlaying further information onto a selected data construct.

20. The social information system of claim 15, further comprising a collaboration system that allows users to engage in online forums about different data constructs.

21. A method for deploying a social information system for managing socio-technical data, comprising:
providing a computer infrastructure being operable to:
capture data from a set of heterogeneous data sources and transforming the data into a common representation;
store the data in a data warehouse in accordance with a defined data model; and
provide a workspace for allowing a user to interact with data from the data warehouse, wherein the workspace allows users to manage data constructs involving socio-technical data and includes a simulation engine for simulating outcomes of socio-technical issues by adjusting at least one variable associated with a data construct.
